(19) United States
(12) Patent Application Publication
(10) Pub. No.: US 2021/0031570 A1
(43) Pub. Date: Feb. 4, 2021

(54) Pneumatic Tire

(71) Applicant: The Yokohama Rubber Co., LTD., Minato-ku, Tokyo (JP)

(72) Inventor: Keisuke Kagaya, Hiratsuka-shi, Kanagawa (JP)

(21) Appl. No.: 16/964,128

(22) PCT Filed: Jan. 20, 2019
(86) PCT No.: PCT/JP2019/001844

§ 371 Date: Jul. 22, 2020

(30) Foreign Application Priority Data
Feb. 14, 2018 (JP) 2018-024353

(51) Int. Cl. B60C 15/04; B60C 13/00; B60C 3/04

(52) U.S. Cl. CPC B60C 15/04; B60C 2009/0284; B60C 3/04; B60C 13/009

(57) ABSTRACT

A pneumatic tire includes a tread portion, a pair of sidewall portions, and a pair of bead portions. A carcass layer is mounted between the bead portions, and the carcass layer is turned up from a tire inner side to a tire outer side about a bead core of each of the pair of bead portions. A tread radius in a meridian cross-section of the tread portion is in a range of from 600 mm to 1700 mm, a ground contact width of the tread portion is in a range of from 60% to 90% of a tire cross-sectional width, and a height of a bead filler is equal to or less than 30% of a tire cross-sectional height.

### TECHNICAL FIELD

The present technology relates to a pneumatic tire and more specifically to a pneumatic tire capable of improving braking performance and reducing rolling resistance.

### BACKGROUND ART

In general, in a pneumatic tire, braking performance is improved by using a cap tread compound having high tan δ for a tread portion. Instead, rolling resistance is increased. Thus, braking performance and rolling resistance have a negative correlation with each other.

Here, it has been proposed that, by flattening a belt layer embedded in a tread portion, shearing deformation of tread rubber during traveling is suppressed, and rolling resistance is reduced (for example, see Japan Unexamined Patent Publication No. 2013-079018). With the structure in which the belt layer is flattened, reduction in rolling resistance can be achieved. However, an effect of achieving both improvement in braking performance and reduction in rolling resistance in a compatible manner cannot be exerted.

### SUMMARY

The present technology provides a pneumatic tire capable of improving braking performance and reducing rolling resistance.

A pneumatic tire of an embodiment of the present technology includes: a tread portion extending in a tire circumferential direction and having an annular shape; a pair of sidewall portions disposed on both sides of the tread portion; and, a pair of bead portions disposed inward of the pair of sidewall portions in a tire radial direction. A carcass layer is mounted between the pair of bead portions, the carcass layer being turned up from a tire inner side to a tire outer side about a bead core of each of the pair of bead portions. A tread radius in a meridian cross-section of the tread portion is in a range of from 600 mm to 1700 mm, a ground contact width of the tread portion is in a range of from 60% to 90% of a tire cross-sectional width, and a height of a bead filler disposed on an outer circumference of the bead core is equal to or less than 30% of a tire cross-sectional height.

In the present technology, a flat tread profile is adopted, and the ground contact width of the tread portion is increased. With this, the ground contact area of the tread portion is increased, and thus braking performance can be improved. Moreover, by reducing the height of the bead filler, a vertical spring constant of the tire is reduced, and the sidewall portion is more likely to be deflected. With this, energy loss in the tread portion is relatively reduced, and thus rolling resistance can be reduced. Further, when the deflection of the sidewall portion is promoted, the ground contact area during braking is increased, which contributes to improvement in braking performance. As a result, braking performance can be improved, and rolling resistance can be reduced.

In the present technology, a tire maximum width position preferably is in a range of from 50% to 60% of a tire cross-sectional height. By setting the tire maximum width position to the range described above, a vertical spring constant of the tire is reduced, and the sidewall portion is more likely to be deflected. With this, energy loss in the tread portion is relatively reduced, and thus rolling resistance can be reduced. Further, the deflection of the sidewall portion can increase the ground contact area.

A rubber thickness at the tire maximum width position of each of the pair of sidewall portions preferably is in a range of from 1 mm to 4 mm. By reducing the rubber thickness at the tire maximum width position of the sidewall portion, a vertical spring constant of the tire is reduced, the ground contact area is increased, and energy loss in the side wall portion is reduced. Thus, rolling resistance can be reduced.

It is preferred that a rubber thickness Gc of a center portion of the tread portion and a rubber thickness Gs of a shoulder portion of the tread portion satisfy a relationship of Gc≥Gs, and that each of the rubber thickness Gc and the rubber thickness Gs of the tread portion is in a range of from 2% to 10% of the tire cross-sectional height. By reducing the thickness of the tread portion as described above, the out-of-plane bending rigidity of the tread portion is reduced, and thus the ground contact area can be increased. Further, by adopting a cap tread compound having low tan δ for the tread portion, hysteresis loss is reduced, and thus resistance can be reduced.

A turned-up height of the carcass layer preferably is in a range of from 10% to 40% of the tire cross-sectional height. By reducing the turned-up height of the carcass layer as described above, a vertical spring constant of the tire is reduced, and the ground contact area is increased. Thus, rolling resistance can be reduced.

Further, it is preferred that the bead core be formed of at least one bead wire wound in the tire circumferential direction, that in a tire meridian cross-section, a plurality of circumferential portions of the bead wire form a plurality of layers overlapping in the tire radial direction, that among the plurality of layers, a layer having a maximum width be positioned inward of a center position in a height direction of the bead core in the tire radial direction, that in the tire meridian cross-section, an external contour shape of the bead core formed by common tangent lines of the plurality of circumferential portions of the bead wire have a polygonal shape having a single apex outward in the tire radial direction, and that an angle formed between two sides sandwiching the apex is an acute angle. By adopting the bead core having such an external contour shape, when the bead filler is reduced or even the bead filler is removed, a satisfactory carcass line can be formed. Thus, excellent tire performance can be exerted while achieving improvement in braking performance and reduction in rolling resistance.

In the present technology, each of the dimensions including a tread radius and a tire cross-sectional height is measured with the tire mounted on a regular rim and inflated to the regular internal pressure. Further, the ground contact width of the tread portion is the ground contact width in a tire axial direction as measured when the tire is mounted on a regular rim and inflated to a regular internal pressure, and placed perpendicularly upon a flat surface with a regular load applied thereto. “Regular rim” is a rim defined by each standard for each tire according to a system of standards that includes standards on which tires are based, refers to a “standard rim” in the case of JATMA (Japan Automobile Tyre Manufacturers Association, Inc.), refers to a “design rim” in the case of TRA (The Tire and Rim Association, Inc.), and refers to a “measuring rim” in the case of ETRTO (European Tire and Rim Technical Organization). “Regular internal pressure” is air pressure defined by each standard for each tire according to a system of standards that includes standards on which tires are based, is referred to as “maximum air pressure” in the case of JATMA, is the maximum value being listed in the table “TIRE ROAD LIMITS AT VARIOUS COLD INFLATION PRESSURES” in the case of TRA, and is “INFLATION PRESSURE” in the case of ETRTO. However, “regular internal pressure” is 180 kPa in a case where the tire is a tire for a passenger vehicle. “Regular load” is a load defined by each standard for each tire according to a system of standards that includes standards on which tires are based, refers to “maximum load capacity” in the case of JATMA, refers to the maximum value in the table of “TIRE ROAD LIMITS AT VARIOUS COLD INFLATION PRESSURES” in the case of TRA, and refers to “LOAD CAPACITY” in the case of ETRTO. When the tire is for use with a passenger vehicle, a load corresponding to 88% of the loads described above is used.

### BRIEF DESCRIPTION OF DRAWINGS

FIG. 1 is a meridian cross-sectional view illustrating a pneumatic tire according to an embodiment of the present technology.

FIG. 2 is a meridian cross-sectional view illustrating a pneumatic tire according to another embodiment of the present technology.

FIG. 3 is a cross-sectional view illustrating a bead core used in the pneumatic tire of FIG. 2.

FIGS. 4A to 4C are cross-sectional views each illustrating a modified example of the bead core used in the pneumatic tire of FIG. 2.

### DETAILED DESCRIPTION

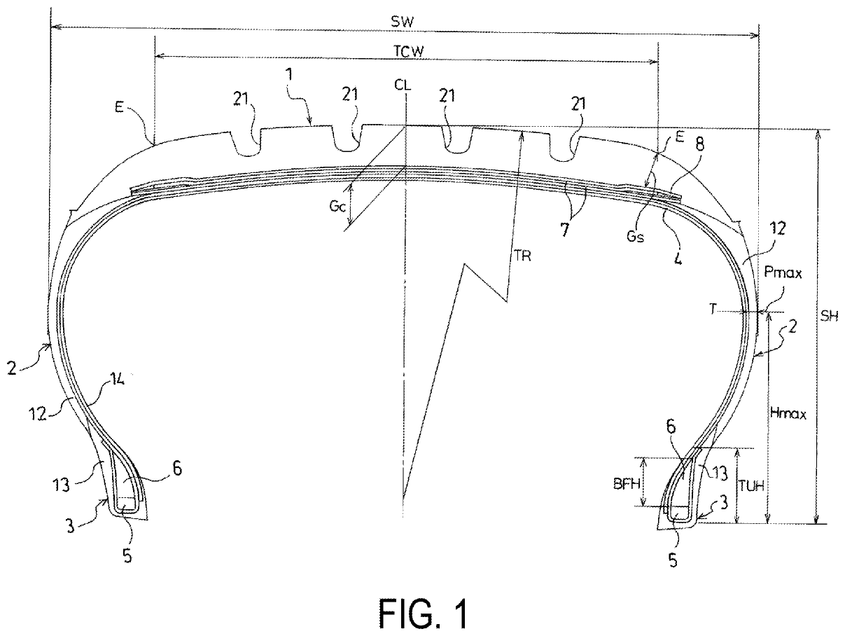

Configurations of embodiments of the present technology will be described in detail below with reference to the accompanying drawings. FIG. 1 illustrates a pneumatic tire according to an embodiment of the present technology. In FIG. 1, CL denotes the tire equator, E denotes the ground contact edges, and TCW denotes the ground contact width.

As illustrated in FIG. 1, a pneumatic tire of the present embodiment includes: a tread portion 1 having an annular shape and extending in a tire circumferential direction, a pair of sidewall portions 2, 2 disposed on both sides of the tread portion 1, and a pair of bead portions 3, 3 disposed inward of the sidewall portions 2 in a tire radial direction.

A carcass layer 4 is mounted between the pair of bead portions 3, 3. The carcass layer 4 includes a plurality of reinforcing cords extending in the tire radial direction and is folded back around bead cores 5 disposed in each of the bead portions 3 from a tire inner side to a tire outer side. A bead filler 6 having a triangular cross-sectional shape and formed from rubber composition is disposed on an outer circumference of the bead core 5. The bead core 5 is formed of at least one bead wire wound in the tire circumferential direction, and the simplified structure thereof is illustrated in FIG. 1.

A plurality of belt layers 7 are embedded on an outer circumferential side of the carcass layer 4 in the tread portion 1. The belt layers 7 each include a plurality of reinforcing cords that are inclined with respect to the tire circumferential direction, the reinforcing cords being disposed between layers in a criss-cross manner. In the belt layers 7, the inclination angle of the reinforcing cords with respect to the tire circumferential direction is in a range of from 10° to 40°, for example. Steel cords are preferably used as the reinforcing cords of the belt layers 7. To improve high-speed durability, at least one belt cover layer 8, formed by arranging reinforcing cords at an angle of, for example, not greater than 5° with respect to the tire circumferential direction, is disposed on an outer circumferential side of the belt layers 7. Nylon, aramid, or similar organic fiber cords are preferably used as the reinforcing cords of the belt cover layer 8.

In the pneumatic tire, a tread rubber layer 11 is disposed outward of the carcass layer 4, the belt layer 7, and the belt cover layer 8 in the tread portion 1. A side rubber layer 12 is disposed outward of the carcass layer 4 in a sidewall portion 2. A rim cushion rubber layer 13 is disposed outward of the carcass layer 4 in the bead portion 3. Additionally, on a tire inner surface, an innerliner layer 14 is disposed along the carcass layer 4. Further, various grooves including a plurality of main grooves 21 extending in the tire circumferential direction are formed in the tread portion 1.

In the pneumatic tire, as illustrated in FIG. 1, a tread radius TR in the meridian cross-section of the tread portion 1 is set to be in a range of from 600 mm to 1700 mm, a ground contact width TCW of the tread portion 1 is set to be in a range of from 60% to 90% of a tire cross-sectional width SW, and a height BFH of the bead filler 6 disposed on the outer circumference of the bead core 5 of the bead portion 3 is set to be in a range equal to or less than 30% of a tire cross-sectional height SH.

In the pneumatic tire described above, a flat tread profile defined by the tread radius TR is adopted, and the ground contact width TCW of the tread portion 1 is increased. With this, the ground contact area of the tread portion 1 is increased, and thus braking performance can be improved. Moreover, by reducing the height BFH of the bead filler 6, a vertical spring constant of the tire is reduced, and the sidewall portion 2 is more likely to be deflected. With this, energy loss in the tread portion 1 is relatively reduced, and thus rolling resistance can be reduced. Further, when deflection of the sidewall portion 2 is promoted, the ground contact area during braking is increased, which contributes to improvement in braking performance. With this, braking performance on dry road surfaces and wet road surfaces can be improved, and rolling resistance can be reduced.

Here, when the tread radius TR in the meridian cross-section of the tread portion 1 is less than 600 mm, the ground contact area is insufficient. In contrast, when the tread radius TR is greater than 1700 mm, contact with the ground in the center region is degraded. Thus, an effect of improving braking performance is degraded. Particularly, the tread radius TR preferably is in a range of from 800 mm to 1500 mm.

Further, when the ground contact width TCW of the tread portion 1 is less than 60% of the tire cross-sectional width SW, the ground contact area is insufficient. In contrast, when the ground contact width TCW is greater than 90%, contact with the ground in the shoulder region is increased while contact with the ground in the center region is degraded. Thus, an effect of improving braking performance is degraded. Particularly, the ground contact width TCW of the tread portion 1 preferably is in a range of from 70% to 80% of the tire cross-sectional width SW.

Further, when the height BFH of the bead filler 6 is greater than 30% of the tire cross-sectional height SH, an effect of reducing rolling resistance cannot be exerted. Particularly, the height BFH of the bead filler 6 preferably is in a range of from 10% to 20% of the tire cross-sectional height SH. Note that the height BFH of the bead filler 6 may be 0% of the tire cross-sectional height SH (that is, a structure without the bead filler 6).

In the pneumatic tire, a height Hmax from the bead heel position to a tire maximum width position Pmax in the tire radial direction preferably is in a range of from 50% to 60% of the tire cross-sectional height SH. By setting the tire maximum width position Pmax in the range described above, a vertical spring constant of the tire is reduced, and the sidewall portion 2 is more likely to be deflected. With this, energy loss in the tread portion 1 is relatively reduced, and thus rolling resistance can be reduced. Further, the deflection of the sidewall portion 2 can increase the ground contact area. Here, the tire maximum width position Pmax is inward of a position being 50% of the tire cross-sectional height SH in the tire radial direction, an effect of reducing a vertical spring constant is degraded. In contrast, when the tire maximum width position Pmax is outward of a position being 60% of the tire cross-sectional height SH in the tire radial direction, the tire structure is unstable, and durability is degraded. Particularly, the height Hmax from the bead heel position to the tire maximum width position Pmax in the tire radial direction preferably is in a range of from 52% to 56% of the tire cross-sectional height SH.

In the pneumatic tire, the rubber thickness T at the tire maximum width position Pmax outward of the carcass layer 4 preferably is in a range of from 1 mm to 4 mm. The rubber thickness T at the tire maximum width position Pmax outward of the carcass layer 4 is set smaller. With this, a vertical spring constant of the tire is reduced, the ground contact area is increased, and energy loss in the sidewall portion 2 is reduced. Thus, rolling resistance can be reduced. Here, when the rubber thickness T is less than 1 mm, cut resistance is degraded. In contrast, when the rubber thickness T is greater than 4 mm, energy loss in the sidewall portion 2 is increased. Particularly, the rubber thickness T preferably is in a range of from 2 mm to 3 mm.

In the pneumatic tire, the rubber thickness Gc of the center portion of the tread portion 1 and the rubber thickness Gs of the shoulder portion of the tread portion 1 preferably satisfy a relationship of Gc≥Gs, and each of the rubber thickness Gc and the rubber thickness Gs is preferably set to be in a range of from 2% to 10% of the tire cross-sectional height SH. By reducing the thickness of the tread portion 1 as described above, out-of-plane bending rigidity of the tread portion 1 is reduced, and thus the ground contact area can be increased. Further, by adopting a cap tread compound having low tan δ for the tread portion 1, hysteresis loss is reduced, and thus resistance can be reduced.

Here, when the rubber thickness Gc and the rubber thickness Gs of the tread portion 1 are less than 2% of the tire cross-sectional height SH, wear life is insufficient. In contrast, when the rubber thickness Gc and the rubber thickness Gs are greater than 10%, an effect of improving braking performance is degraded due to increase of the ground contact area. Particularly, each of the rubber thickness Gc and the rubber thickness Gs of the tread portion 1 preferably is in a range of from 3% to 7% of the tire cross-sectional height SH. Note that the rubber thickness Gc of the center portion of the tread portion 1 is the rubber thickness measured in the normal line direction of the road contact surface at the position of the tire equator CL or a position equivalent thereto (for example, when a main groove is disposed on the tire equator CL, a position closest to the tire equator CL), and the rubber thickness Gs of the shoulder portion of the tread portion 1 is the rubber thickness measured in the normal line direction of the road contact surface at the position of the ground contact edge E. Each of the rubber thickness Gc and the rubber thickness Gs is the thickness of the rubber portion outward of the reinforcing layers such as the belt layer 7 and the belt cover layer 8.

In the pneumatic tire, a turned-up height TUH of the carcass layer 4 preferably is in a range of from 10% to 40% of the tire cross-sectional height SH. By reducing the turned-up height TUH of the carcass layer 4 as described above, a vertical spring constant of the tire is reduced, and the ground contact area is increased. Thus, rolling resistance can be reduced. Here, when the turned-up height TUH of the carcass layer 4 is less than 10% of the tire cross-sectional height SH, rigidity around the bead portion 3 is insufficient. In contrast, when the turned-up height TUH is greater than 40%, an effect of reducing a vertical spring constant is degraded. Particularly, the turned-up height TUH of the carcass layer 4 preferably is in a range of from 20% to 30% of the tire cross-sectional height SH.

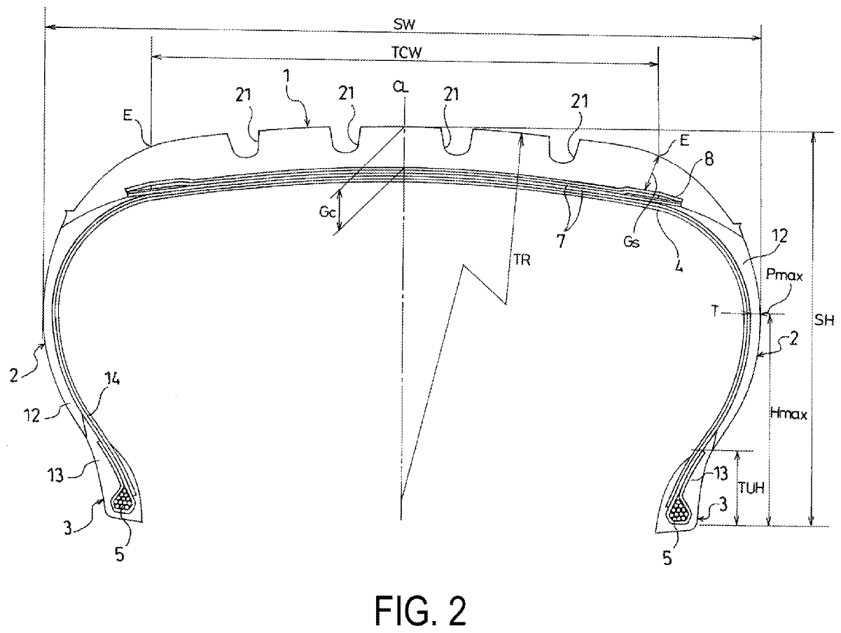

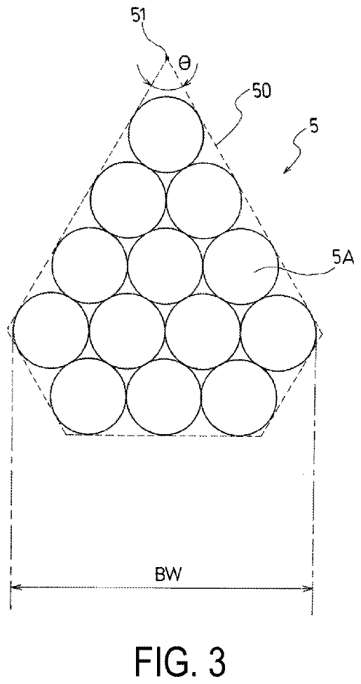

FIG. 2 is a view illustrating a pneumatic tire according to another embodiment of the present technology, and FIG. 3 is a view illustrating a bead core used in the pneumatic tire. In FIG. 2, components that are identical to those in FIG. 1 have the same reference signs, and detailed descriptions of those components are omitted. In the present embodiment, in comparison with the embodiment described above, only the structure of the bead portion 3 is changed.

As illustrated in FIG. 2 and FIG. 3, the bead core 5 is formed of at least one bead wire 5A wound in the tire circumferential direction, and in the tire meridian cross-section, a plurality of circumferential portions of the bead wire 5A form a plurality of layers overlapping in the tire radial direction. In the illustrated example, a structure is provided in which a total of five layers: a layer including three circumferential portions; a layer including four circumferential portions; a layer including three circumferential portions; a layer including two circumferential portions; and a layer including one circumferential portion are stacked in the mentioned order from the innermost side in the tire radial direction. Among the layers, the layer having the maximum width BW (that is, the layer including four rows of the circumferential portions) is positioned inward of the center position in a height direction of the bead core 5 in the tire radial direction. In the tire meridian cross-section, an external contour shape 50 of the bead core 5 formed by common tangent lines of the plurality of circumferential portions of the bead wire 5A forms a polygonal shape having a single apex 51 outward in the tire radial direction and has an angle θ being an acute angle formed between two sides sandwiching the apex 51. That is, the bead core 5 as a whole has a tapered shape having a width being gradually reduced from the portion having the maximum width BW toward outside in the tire radial direction. In FIG. 2, a structure is provided in which the bead filler 6 is not disposed on the outer circumference of the bead core 5 and in which the carcass layer 4 turned up about the bead core 5 has the main portion and the turned-up portion being in contact with each other at the position of the apex 51 of the bead core 5.

By adopting the bead core 5 having such an external contour shape, when the bead filler 6 is reduced or even the bead filler 6 is removed, a satisfactory carcass line can be formed. Thus, excellent tire performance can be exerted while achieving improvement in braking performance and reduction in rolling resistance. Particularly, as illustrated in FIG. 3, the bead core 5 having a structure in which the external contour shape 50 forms a pentagonal shape, the positions of the circumferential portions of the bead wire 5A are deviated in the tire lateral direction, and the tire radial outermost layer has a single circumferential portion can exert stability in a satisfactory shape.

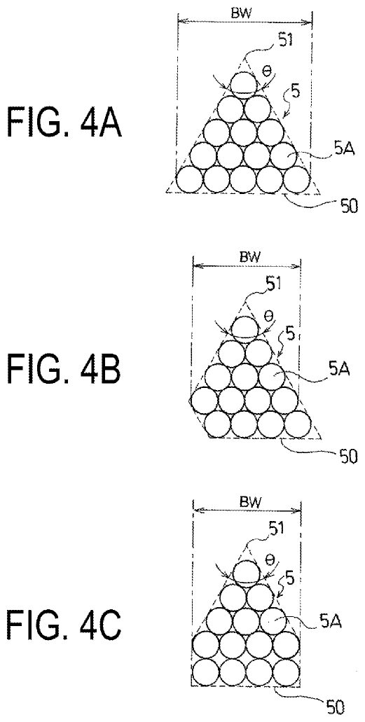

FIGS. 4A to 4C are views each illustrating a modified example of the bead core used in the pneumatic tire of FIG. 2. In FIGS. 4A to 4C, the bead core 5 is formed of at least one bead wire 5A wound in the tire circumferential direction. In the tire meridian cross-section, the plurality of circumferential portions of the bead wire 5A form a plurality of layers overlapping in the tire radial direction. Among those layers, the layer having the maximum width BW is positioned inward of the center position in the height direction of the bead core 5 in the tire radial direction. The external contour shape 50 of the bead core 5 formed by common tangent lines of the plurality of circumferential portions of the bead wire 5A forms a polygonal shape having the single apex 51 outward in the tire radial direction and has the angle θ being an acute angle formed between the two sides sandwiching the apex 51. Particularly, the external contour shape 50 has a triangular shape in FIG. 4A, the external contour shape 50 has a quadrangular shape in FIG. 4B, and the external contour shape 50 has a pentagonal shape in FIG. 4C. The bead cores 5 as described herein are also effective.

### Example

Tires of Conventional Example, Examples 1 to 12, and Comparative Examples 1 to 4 were produced. Each of the tires had a tire size of 205/60R16 92V and included: a tread portion, a pair of sidewall portions, and a pair of bead portions. A carcass layer was mounted between the pair of bead portions, and the carcass layer was turned up from a tire inner side to a tire outer side about a bead core of each of the pair of bead portion. The produced tires were set to satisfy the following matters as shown in Table 1: the tread radius TR; a ratio of the ground contact width TCW with respect to the tire cross-sectional width SW (TCW/SW×100%); a ratio of the height BFH of the bead filler with respect to the tire cross-sectional height SH (BFH/SH×100%); a ratio of the height Hmax of the tire maximum width position Pmax with respect to the tire cross-sectional height SH (Hmax/SH×100%); the rubber thickness T at the tire maximum width position Pmax; a ratio of the rubber thickness Gc of the center portion of the tread portion with respect to the tire cross-sectional height SH (Gc/SH×100%); a ratio of the rubber thickness Gs of the shoulder portion of the tread portion with respect to the tire cross-sectional height SH (Gs/SH×100%); a ratio of the turned-up height TUH of the carcass layer with respect to the tire cross-sectional height SH (TUH/SH×100%); and the structure of the bead core (FIG. 1 or FIG. 2).

Braking performance and rolling resistance for these test tires were evaluated according to the following test methods, and the results are shown in Table 1.

### Braking Performance:

Each of the test tires was assembled on a wheel with a rim size of 16×6.0 J, mounted on a front wheel drive vehicle having an engine displacement of 1500 cc, and inflated to an air pressure of 180 kPa. A braking distance was measured after ABS braking from a state of driving at a speed of 100 km/h on a test course with a dry road surface under a load condition equivalent to two passengers. The evaluation results were expressed as index values by using the reciprocals of the measurement values, with the value of the Conventional Example being defined as 100. Larger index values indicate superior braking performance on dry road surfaces.

### Rolling Resistance:

Each of the test tires was assembled on a wheel with a rim size of 16×6.0 J and mounted on a rolling resistance tester. Pre-running was performed for 30 minutes at an air pressure of 230 kPa, a load of 4.5 kN, and a speed of 80 km/h, and then rolling resistance was measured under the same conditions. The evaluation results were expressed as index values by using the reciprocals of the measurement values, with the value of the Conventional Example being defined as 100. Higher index values indicate lower rolling resistance.

TABLE 1

| | Conventional | Comparative | | | |
|---|---|---|---|---|---|
| | Example | Example 1 | Example 1 | Example 2 | Example 3 |
| TR (mm) | 550 | 500 | 600 | 1200 | 1700 |
| TCW/SW × 100% | 60 | 75 | 75 | 75 | 75 |
| BFH/SH × 100% | 30 | 15 | 15 | 15 | 15 |
| Hmax/SH × 100% | 45 | 45 | 45 | 45 | 45 |
| Rubber thickness T (mm) | 5 | 5 | 5 | 5 | 5 |
| Gc/SH × 100% | 11 | 11 | 11 | 11 | 11 |
| Gc/SH × 100% | 11 | 11 | 11 | 11 | 11 |
| TUH/SH × 100% | 50 | 50 | 50 | 50 | 50 |
| Bead core structure | (FIG. 1) | FIG. 1 | FIG. 1 | FIG. 1 | FIG. 1 |
| Braking performance (index) | 100 | 100 | 102 | 105 | 102 |
| Rolling resistance (index) | 100 | 105 | 105 | 105 | 105 |

| | Comparative | Comparative | | | Comparative |
|---|---|---|---|---|---|
| | Example 2 | Example 3 | Example 4 | Example 5 | Example 4 |
| TR (mm) | 1800 | 1200 | 1200 | 1200 | 1200 |
| TCW/SW × 100% | 75 | 55 | 60 | 90 | 95 |
| BFH/SH × 100% | 15 | 15 | 15 | 15 | 15 |
| Hmax/SH × 100% | 45 | 45 | 45 | 45 | 45 |
| Rubber thickness T (mm) | 5 | 5 | 5 | 5 | 5 |
| Gc/SH × 100% | 11 | 11 | 11 | 11 | 11 |
| Gc/SH × 100% | 11 | 11 | 11 | 11 | 11 |
| TUH/SH × 100% | 50 | 50 | 50 | 50 | 50 |
| Bead core structure | FIG. 1 | FIG. 1 | FIG. 1 | FIG. 1 | FIG. 1 |
| Braking performance (index) | 100 | 100 | 102 | 102 | 100 |
| Rolling resistance (index) | 105 | 105 | 105 | 105 | 105 |

| | Example 6 | Example 7 | Example 8 | Example 9 | Example 10 | Example 11 | Example 12 |
|---|---|---|---|---|---|---|---|
| TR (mm) | 1200 | 1200 | 1200 | 1200 | 1200 | 1200 | 1200 |
| TCW/SW × 100% | 75 | 75 | 75 | 75 | 75 | 75 | 75 |
| BFH/SH × 100% | 10 | 20 | 15 | 15 | 15 | 15 | 0 |
| Hmax/SH × 100% | 45 | 45 | 55 | 55 | 55 | 55 | 55 |
| Rubber thickness T (mm) | 5 | 5 | 5 | 3 | 3 | 3 | 3 |
| Gc/SH × 100% | 11 | 11 | 11 | 11 | 5 | 5 | 5 |
| Gc/SH × 100% | 11 | 11 | 11 | 11 | 5 | 5 | 5 |
| TUH/SH × 100% | 50 | 50 | 50 | 50 | 50 | 25 | 25 |
| Bead core structure | FIG. 1 | FIG. 1 | FIG. 1 | FIG. 1 | FIG. 1 | FIG. 1 | FIG. 2 |
| Braking performance (index) | 105 | 105 | 108 | 110 | 115 | 118 | 120 |
| Rolling resistance (index) | 108 | 104 | 107 | 110 | 112 | 115 | 117 |

As shown in Table 1, in comparison with the Conventional Examples, the tires of Examples 1 to 12 were able to improve braking performance and reduce rolling resistance. In contrast, the tires of Comparative Examples 1 to 4 did not satisfy the predetermined dimension requirements, and hence an effect of improving braking performance was not exerted sufficiently.

1. A pneumatic tire, the pneumatic tire comprising:
a tread portion extending in a tire circumferential direction and having an annular shape;
a pair of sidewall portions disposed on both sides of the tread portion; and
a pair of bead portions disposed inward of the pair of sidewall portions in a tire radial direction, wherein
a carcass layer is mounted between the pair of bead portions, the carcass layer being turned up from a tire inner side to a tire outer side about a bead core of each of the pair of bead portions,
a tread radius in a meridian cross-section of the tread portion is in a range of from 600 mm to 1700 mm,
a ground contact width of the tread portion is in a range of from 60% to 90% of a tire cross-sectional width, and
a height of a bead filler disposed on an outer circumference of the bead core is equal to or less than 30% of a tire cross-sectional height.

2. The pneumatic tire according to claim 1, wherein a tire maximum width position is in a range of from 50% to 60% of the tire cross-sectional height.

3. The pneumatic tire according to claim 1, wherein a rubber thickness at the tire maximum width position of each of the pair of sidewall portions is in a range of from 1 mm to 4 mm.

4. The pneumatic tire according to claim 1, wherein a rubber thickness Gc of a center portion of the tread portion and a rubber thickness Gs of a shoulder portion of the tread portion satisfy a relationship of Gc≥Gs, and each of the rubber thickness Gc and the rubber thickness Gs of the tread portion is in a range of from 2% to 10% of the tire cross-sectional height.

5. The pneumatic tire according to claim 1, wherein a turned-up height of the carcass layer is in a range of from 10% to 40% of the tire cross-sectional height.

6. The pneumatic tire according to claim 1, wherein
the bead core is formed of at least one bead wire wound in the tire circumferential direction,
in a tire meridian cross-section, a plurality of circumferential portions of the bead wire form a plurality of layers overlapping in the tire radial direction,
among the plurality of layers, a layer having a maximum width is positioned inward of a center position in a height direction of the bead core in the tire radial direction,
in the tire meridian cross-section, an external contour shape of the bead core formed by common tangent lines of the plurality of circumferential portions of the bead wire has a polygonal shape having a single apex outward in the tire radial direction, and
an angle formed between two sides sandwiching the apex is an acute angle.

7. The pneumatic tire according to claim 2, wherein a rubber thickness at the tire maximum width position of each of the pair of sidewall portions is in a range of from 1 mm to 4 mm.

8. The pneumatic tire according to claim 7, wherein a rubber thickness Gc of a center portion of the tread portion and a rubber thickness Gs of a shoulder portion of the tread portion satisfy a relationship of Gc≥Gs, and each of the rubber thickness Gc and the rubber thickness Gs of the tread portion is in a range of from 2% to 10% of the tire cross-sectional height.

9. The pneumatic tire according to claim 8, wherein a turned-up height of the carcass layer is in a range of from 10% to 40% of the tire cross-sectional height.

10. The pneumatic tire according to claim 9, wherein
the bead core is formed of at least one bead wire wound in the tire circumferential direction,
in a tire meridian cross-section, a plurality of circumferential portions of the bead wire form a plurality of layers overlapping in the tire radial direction,
among the plurality of layers, a layer having a maximum width is positioned inward of a center position in a height direction of the bead core in the tire radial direction,
in the tire meridian cross-section, an external contour shape of the bead core formed by common tangent lines of the plurality of circumferential portions of the bead wire has a polygonal shape having a single apex outward in the tire radial direction, and
an angle formed between two sides sandwiching the apex is an acute angle.
